(19) United States
(12) Patent Application Publication
(10) Pub. No.: US 2023/0300111 A1
(43) Pub. Date: Sep. 21, 2023

(54) SYSTEM AND METHOD FOR NETWORK-CONNECTED DEVICE SECURITY

(71) Applicant: CenturyLink Intellectual Property LLC, Broomfield, CO (US)

(72) Inventors: John R.B. Woodworth, Amissville, VA (US); Dean Ballew, Sterling, VA (US)

(73) Assignee: CenturyLink Intellectual Property LLC, Broomfield, CO (US)

(21) Appl. No.: 18/157,368

(22) Filed: Jan. 20, 2023

Related U.S. Application Data
(60) Provisional application No. 63/269,354, filed on Mar. 15, 2022.

(51) Int. Cl. H04L 9/40; H04L 61/4511

(52) U.S. Cl. CPC H04L 63/0236; H04L 61/4511; H04L 63/102

(57) ABSTRACT

Internet-connected devices are commonly used in various applications including home automation and industrial telemetry and control. Such devices may have relatively constrained needs for the various types of communications that are possible within the local network and with other devices on the internet, but the networks to which they are connected may nonetheless grant such devices unrestricted access. This may result in vulnerabilities that may be exploited by a malicious actor. As such, a system and method for providing security to internet-connected devices are provided.

### CROSS-REFERENCE TO RELATED APPLICATIONS

This application claims the benefit of U.S. Provisional Application No. 63/269,354 filed on Mar. 15, 2022, entitled “System and Method for Network-Connected Device Security,” which is incorporated herein by reference in its entirety.

### FIELD

One or more aspects of embodiments according to the present disclosure relate to internet-connected devices, and more particularly to a system and method for providing security to internet-connected devices.

### BACKGROUND

Internet-connected devices are commonly used in various applications including home automation and industrial telemetry and control. Such devices may have relatively constrained needs for the various types of communications that are possible within a local network and with other devices on a wide-area network, such as the internet, but the networks to which they are connected may nonetheless grant such devices unrestricted access. This may result in vulnerabilities that may be exploited by a malicious actor.

It is with respect to this general technical environment that aspects of the present disclosure are related.

### SUMMARY

A system and method for providing security to network-connected devices is provided. In an aspect, a method includes receiving, by a security device for a first network segment, a request from a device to be configured to receive or transmit data on the first network segment, and determining, based on the request to be configured, a first profile for the device. The method may further include receiving, by the security device, a data packet, the data packet being a data packet from the device, or a data packet addressed to the device; determining, by the security device, based on the first profile, that forwarding of the data packet is not authorized, and not forwarding, by the security device, the data packet.

### BRIEF DESCRIPTION OF THE DRAWINGS

These and other features and advantages of the present disclosure will be appreciated and understood with reference to the specification, claims, and appended drawings wherein:

FIG. 1 is a block diagram of a local network connected to the internet, according to an embodiment of the present disclosure;

FIG. 2 is an example of a set of profiles, according to an embodiment of the present disclosure;

FIG. 3A is a flow chart of a method, according to an embodiment of the present disclosure;

FIG. 3B is a flow chart of a method, according to an embodiment of the present disclosure;

FIG. 3C is a flow chart of a method, according to an embodiment of the present disclosure;

FIG. 3D is a flow chart of a method, according to an embodiment of the present disclosure;

FIG. 3E is a flow chart of a method, according to an embodiment of the present disclosure;

FIG. 3F is a flow chart of a method, according to an embodiment of the present disclosure;

FIG. 3G is a flow chart of a method, according to an embodiment of the present disclosure;

FIG. 3H is a flow chart of a method, according to an embodiment of the present disclosure; and

FIG. 4 is a block diagram of an operating environment, according to an embodiment of the present disclosure.

### DETAILED DESCRIPTION

The detailed description set forth below in connection with the appended drawings is intended as a description of exemplary embodiments of a system and method for providing security to network-connected devices provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

Internet of Things (IoT) devices may comprise common user devices, such as an internet-connect refrigerator, an internet-connected thermostat, or an internet-connected home automation controller, etc. Industrial Internet of Things (IIoT) devices may be user devices used in industry, such as internet-connected process sensors providing telemetry for industrial processes, or internet-connected Computer Numerically Controlled (CNC) machines. Such a device, or a set of such devices, may be connected to the internet through a security device, such as a router (or such as a gateway or firewall). IoT devices, IIoT devices, and user computing devices (e.g., desktop, laptop, or tablet computers) are collectively referred to herein simply as “devices.”

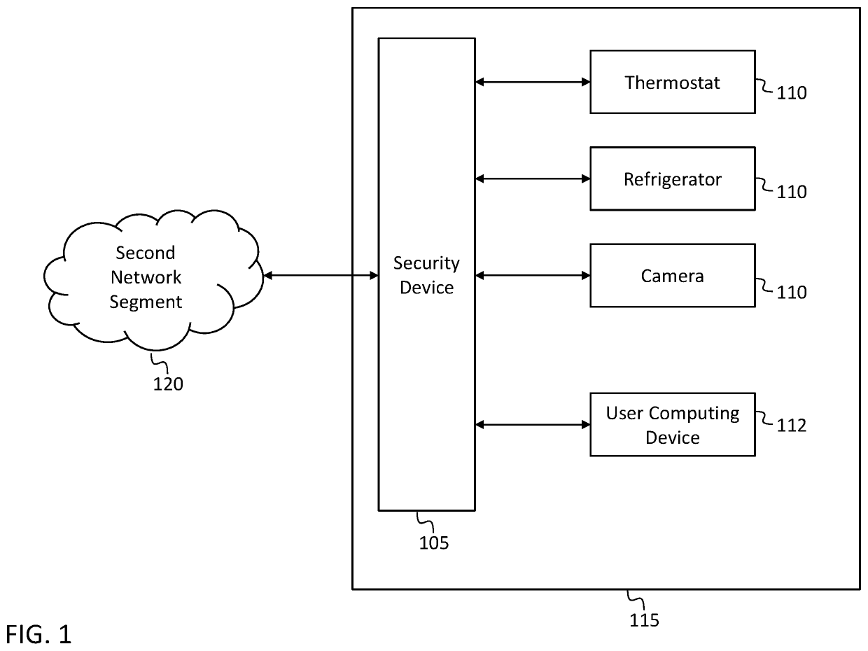

FIG. 1 shows an example of a first network segment 115 (such as a local area network, e.g., home network) including a security device 105 connecting the first network segment 115 to a second network segment 120 (such as the internet), and a plurality of devices 110, such as an internet-connected thermostat, an internet-connected refrigerator, and an internet-connected video camera, and a user computing device 112 (e.g., a laptop). Devices 110 and 112 that are connected (e.g., through wired or wireless connections) to the security device 105 may also be referred to herein as connected devices. In examples, the security device 105 may comprise a router, a modem, a gateway, a firewall, and/or a combination thereof. In examples, the first network segment 115 and the second network segment 120 may comprise separate, but operatively connected networks, such as a home network and the internet, respectively. In other examples, the first network segment 115 and the second network segment 120 may comprise separate security zones of the same network, among other possibilities. The security device 105 may treat all device traffic within the first network segment 115 in the same way, without distinguishing, in this example, between the IoT devices 110, and another user device 112. This behavior, on the part of the security device 105, may result in unnecessary security vulnerabilities, in part because, for example, the IoT devices 110 may needlessly have the same access, to the second network segment (e.g., the internet) and to other devices 110 and 112 connected to the security device 105, as a user computing device 112 would have. For example, an internet-connected thermostat 110, which may not have a need to accept firmware updates pushed to it, may be compromised by a malicious actor, who may push malicious firmware to the thermostat 110. Once compromised, the thermostat, which ordinarily may have no need for peer-to-peer communications with other IoT devices 110 on the local network, may access, and compromise (or “infect”), other IoT devices 110 or the user computing device 112 connected to the same security device 105.

As such, in some embodiments, a router 105 may distinguish, in determining whether to forward data packets (e.g., Transmission Control Protocol/Internet Protocol (TCP/IP) packets) that it receives from, or that are addressed to, a device 110 connected to it, based on the characteristics of the device 110. Each device 110 may be associated with one or more profiles, each of which may correspond to a service that the device 110 is expected to provide, or that the device 110 is expected to consume. As used herein, a “profile” may comprise a data structure containing one or more parameters characterizing a service that the device 110 is expected to provide, or that the device 110 is expected to consume. Based on the profiles of a device 110, the security device 105 may decide, for any packet from, or addressed to, the device 110, whether to forward the packet. The parameters may be used by the security device 105, e.g., in a set of rules, to determine whether the forwarding of a given packet is authorized under the profiles associated with the device 110, and the security device 105 may forward the packet (to the address specified by the device 110, or to the device 110) only if such forwarding is authorized. The security device 105 may make the determination based only on the contents of the packet header, or it may also employ deep packet inspection to determine characteristics of the payload. If the forwarding of the packet is not authorized under any of the profiles associated with a device 110, the security device 105 may simply drop the packet, or drop the packet and (i) update statistics it may maintain related to dropped packets, or (ii) save the packet in a log of unauthorized packets, for future inspection by a user managing the local network (e.g., via user computing device 112).

Each profile may have a name, which may be useful if the user (e.g., an administrator of the first network segment 115) is to participate in the setting up of the security device 105 with a device 110. Parameters that may be defined in a profile may include ports at which the device 110 may receive packets, ports to which the device 110 may send packets, whether the device 110 is permitted to perform peer-to-peer access (e.g., to access other devices 110 connected (or directly connected) to the same security device 105), times (e.g., times of day) during which access is permitted, Internet Protocol (IP) addresses to which the device 110 is permitted to send packets, average data rates at which the device 110 is permitted to send or receive data, and protocols the device 110 is permitted to employ (e.g., File Transfer Protocol (FTP), Server Message Block (SMB), or Secure Shell (SSH)). The profile may also include, for example, parameters specifying whether the device 110 is permitted to perform peer-to-peer access (e.g., access to other devices 110 directly connected to the same security device 105), whether the device 110 is permitted to accept pushed updates, or whether the device 110 is permitted to send a Domain Name System (DNS) query to a resolver other than the resolver of the security device 105. The security device 105 may detect attempts to push an update to the device 110 based on port numbers, or, if the security device 105 has enough processing power and visibility (e.g., if the packets are unencrypted), it may prevent certain POSTs or URLs from being processed. In some embodiments, the security device may perform (or require) proxy functions for certain protocols in order to gain additional visibility. Peer-to-peer restrictions may prevent an infected device from infecting peers while allowing, e.g., a laptop to access a video camera that is its peer.

Other profile parameters may specify whether certain other behaviors (e.g., scanning behaviors), that for example in an IoT device 110 may be an indication that the device 110 has been infected, are permitted, or whether a device 110 may receive packets having characteristics indicating known attack vectors. For example, the security device 105 may block a packet sent by a device 110 to a particular IP address if the device 110 has recently sent packets to multiple (e.g., 10 or more) different ports at the same IP address, and the security device 105 may block a packet addressed to a device 110 if the device 110 has received packets (e.g., from the same source IP address), at multiple (e.g., 10 or more) different ports. In some embodiments, device “signatures” may be stored by the security device 105, which may include the expected behavior of the device. For example, the device signature of a device 110 may indicate that port 80 may be used to select a stream, followed by connection to port 88 for Real Time Streaming Protocol (RTSP). This may form additional security if another device attempts to access a profiled device 110, or the profiled device 110 attempts to access other devices.

The security device 105 may store and recognize a set of standardized profiles (including, e.g., one or more device signature), each with default parameter values (which may or may not be capable of being overridden upon request by a device 110 or user computing device 112). The security device 105 may be capable (e.g., via firmware update) of updating the standardized profiles or of adding new standardized profiles, if the standard defining them is updated. The behavior of the security device 105 may change as a result of such updates; for example, after an update the security device 105 may decline to forward certain packets that, prior to the update, it would have forwarded. The security device 105 may also be capable of receiving, from a device 110, a request to be associated with a non-standard profile, a definition of which is supplied by the device 110, and then associating (or declining to associate) the device 110 with the profile. In examples, the user computing device 112 may be used to control what profile is associated with a device 110 when registering with the security device 105. For example, a user of user computing device 112 may be requested to approve assigning a “security camera” profile when a new camera device 110 is configured for use on first network segment 115 (e.g., when the new camera device 110 engages the security device 105 in the DHCP process of obtaining an internet protocol (IP) address).

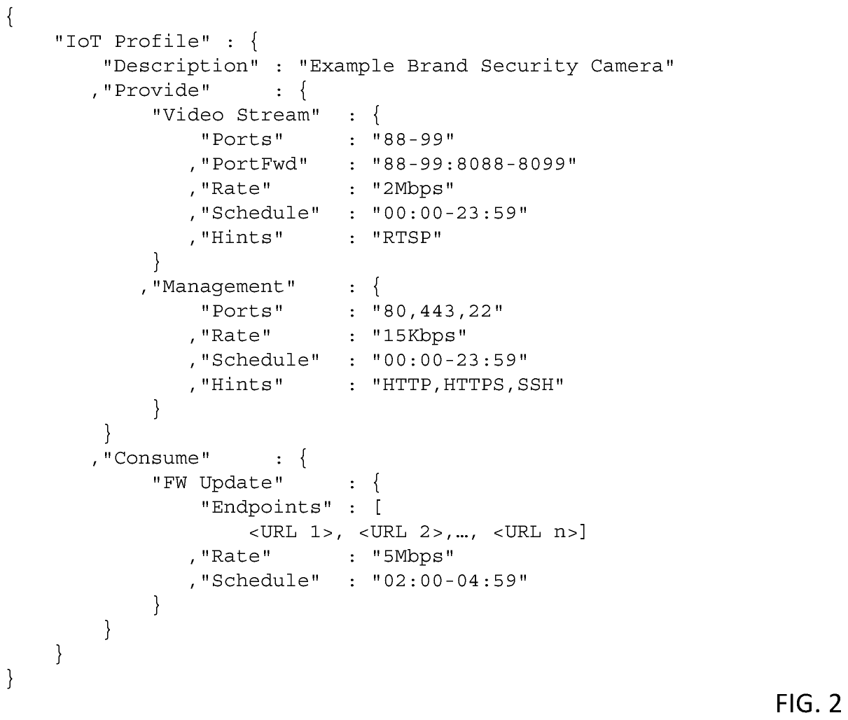

The data structure of FIG. 2 shows an example of a set of profiles, which may be employed, for example, for an internet-connected video camera, which is a non-exclusive example of a device 110. The non-exclusive, example data structure of FIG. 2 is formatted in JavaScript Object Notation (JSON) format; in other embodiments any other format suitable for representing the data structure of a profile may be employed. In the example of FIG. 2, the device 110 (the camera) has three profiles. The first two profiles, named “Video Stream,” and “Management,” are for services it provides, and the third, named “FW Update,” is for a service it consumes. In operation, when the security device 105 receives a packet from the device 110, it may check the packet against all of the profiles, and (i) forward the packet to the IP address specified in the packet header if the packet complies with the rules associated with any of the profiles, or (ii) otherwise, not forward the packet. In examples, “not forwarding” a packet may comprise dropping the packet or forwarding the packet to a destination to which it was not addressed as part of a threat mitigation scheme. When the camera is capturing and serving video, it may send, to one or more clients, packets complying with the profile named “Video Stream.” In the illustrated example, a packet may comply with the profile named “Video Stream” only if (i) it is addressed to one of the ports specified in the “Ports” parameter, (ii) the average data rate, if the packet is forwarded, will not exceed the rate specified by the “Rate” parameter, and (iii) the time at which the packet was received is within the range of times specified by the “Schedule” parameter.

The “Provide” portion of the profile may be for inbound connections, and the “Consume” portion of the profile may be for outbound connections. In some embodiments (e.g., to handle a situation in which a device is trying to establish a “callback” on a provided service (e.g., FTP “active” mode transfers)), other conventions may be employed; for example, parameters such as “Listen-Ports” and “Outbound-Ports” may be defined (for inbound and outbound connections, respectively) and included in a profile instead of, or in addition to, the “Ports” parameter. The “PortFwd” parameter may allow the device 110 to request port-forwarding from the security device 105. For example, the security device 105 may provide a network address translation (NAT) service, whereby internet protocol (IP) addresses on the inside of the first data segment 115 (e.g., a Local Area Network (LAN)) are unreachable from the outside (e.g., the second network segment 120, which may comprise a Wide Area Network (WAN)). Port forwarding may create a listening port on the WAN side of the security device 105 for each of one or more ports that are forwarded to the ports “provided” by the inside device 110. This parameter may assume (authorized) automatic port-forwarding (e.g., Universal Plug and Play (UPnP) port forwarding). The “Hints” parameter may be a string that may be easier to understand by the end user. It may also be standardized and formalized, and it may be used to inform the security device 105 which protocols are expected to run over the ports. In the latter case, the parameter may be named “Protocols,” for example.

In the example of FIG. 2, the “Management” profile may be used by the device 110 when it is being configured. The determination of whether a packet complies with the “Management” profile during a configuration process may be analogous to the determination of whether a packet complies with the “Video Stream” profile.

The “FW-Update” profile may be used by the device 110 when it is checking for firmware updates. For example, the “Endpoints” parameter may include a list of Uniform Resource Locators (URLs) or IP addresses from which the device 110 is authorized to fetch firmware updates, and the “Schedule” parameter may specify a limited time window, so that attempts to fetch an update at an unauthorized time may be detected, by the security device 105, and used to detect and foil an attempt by a malicious actor to perform an illegitimate firmware update. The detection of such an attempt may cause the security device 105 to disable the “FW-Update” profile of the device 110 (e.g., cause all attempted updates to be failed) until re-enabled by an administrator (e.g., through user computing device 112). If a device 110 is configured to receive pushed updates, then such updates may be similarly constrained (e.g., permitted only within one or more limited time windows or from particular URLs or IP addresses).

Other profiles may be defined in an analogous manner for services such as audio streaming, file storage, HTTP (used by a device 110 implementing the server side of the HTTP protocol (e.g., Apache, NGINX, etc.)), remote telemetry, home automation events, domain name resolution, email messaging, printer, scanner, and software defined radio. User computing devices (such as user computing device 112) may use an entirely (or largely) unrestricted profile, which may be named “All” (or “All Access” or “Any”).

In some embodiments, the association of profiles with a device 110 may occur when the device 110 is first connected to the security device 105, or when the device 110 is powered up. The device 110 may then negotiate its profiles with the security device 105; for example, the device 110 may request to be associated with certain profiles (e.g., by sending, to the security device 105, a name (and, optionally, a set of parameter values to be used to override standard parameter values) for each requested profile) and the security device 105 may, in response, associate, or decline to associate, the device 110 with one more or the requested profiles. In some embodiments, the Dynamic Host Configuration Protocol (DHCP) may be adapted to support the negotiation between the device 110 and the security device 105.

The decision regarding whether or not to grant the requested association of a device 110 to a profile may be based on one or more of several factors. For example, if after a firmware update, the device 110 requests additional profiles, the security device 105 may decline the request, especially if the newly requested profiles would give the device 110 significant additional freedom to communicate, such as a profile that permits peer-to-peer access, when peer-to-peer access was not authorized for any of the profiles previously associated with the device 110.

In some embodiments the security device 105 may operate autonomously (without user participation) in associating profiles with devices 110; in other embodiments a user may participate (using a suitable interface to the security device 105, as discussed in further detail below) in the association of profiles with a device 110. For example, the security device 105 may be configured (e.g., hard coded, or configured by its firmware, or configured by a user-settable parameter) not to associate a profile with a device 110 without the concurrence of an authorized user, e.g., via user computing device 112. Such a process may have the advantage that the user may have independent information about the nature of the device 110, which may allow the user to determine more reliably than the security device 105 whether a certain profile is appropriate for the device 110. For example, if a thermometer, after installing an update, requests to be associated with the profile “All,” the user, aware that the device 110 is a thermostat, may instruct the security device 105 not to grant the association request. In such a circumstance the security device 105 may also automatically take other actions (such as disconnecting the thermostat from the first network segment) until explicitly re-added by an authorized user.

In some embodiments, as mentioned above, the security device 105 may provide a user interface that the user may use for management and reporting functions. For example, the security device 105 user interface may be a web site associated with the security device 105, which the user may access by navigating to it, using a browser running on a user computing device 112. In other examples, the user interface is operating on a user computing device 112 that is directly connected to the security device 105 within the first network segment. Such an interface may allow the user to participate, e.g., as described above, in the determination of whether a device's profile requests are granted. It may also allow the user to view data related to the security device's security operations, such as statistics on the number of packets, from a particular device 110, during a recent time interval (e.g., during the past day or during the past week) that the security device 105 declined to forward. Such statistics may allow the user to determine that a device 110 has been infected.

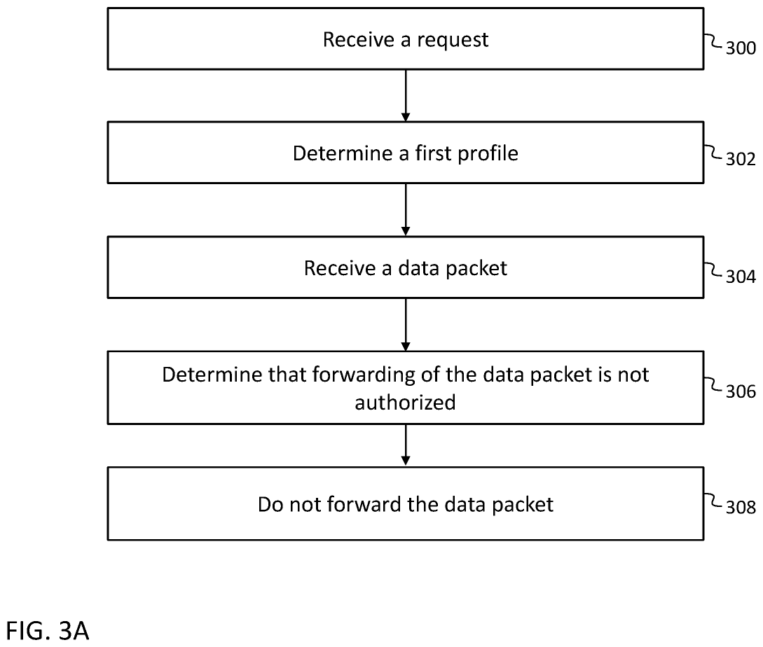

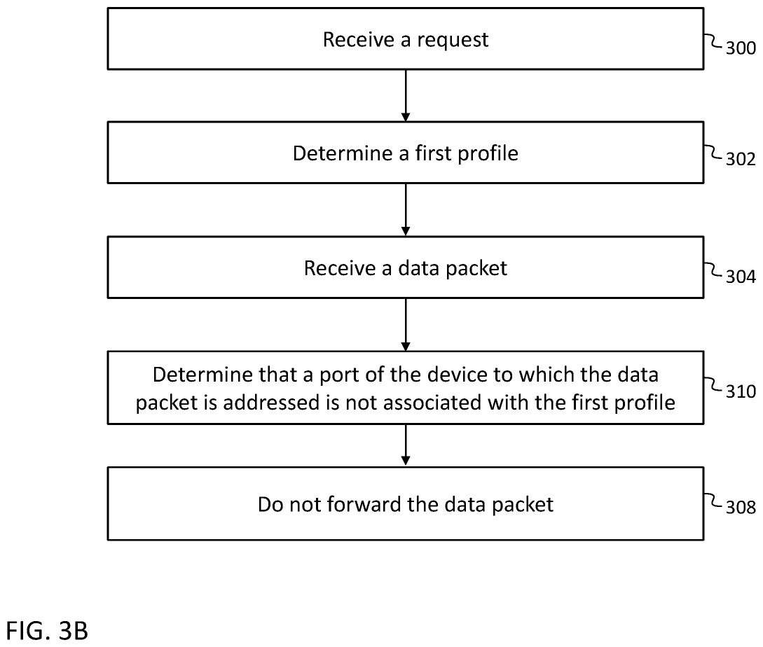

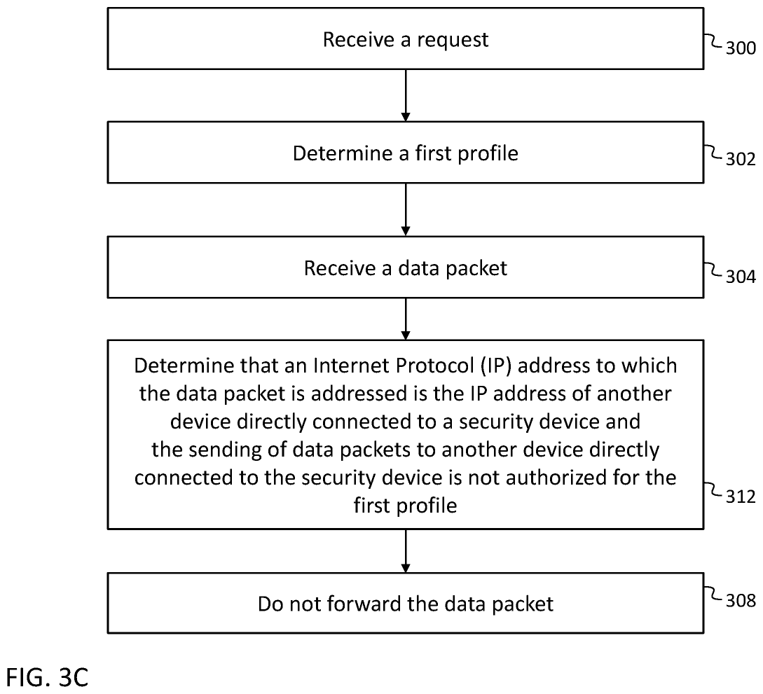

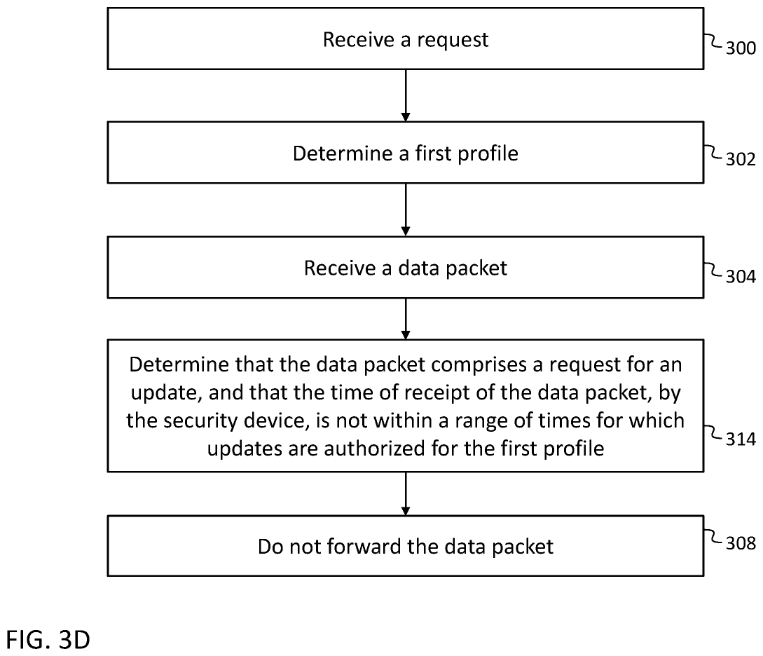

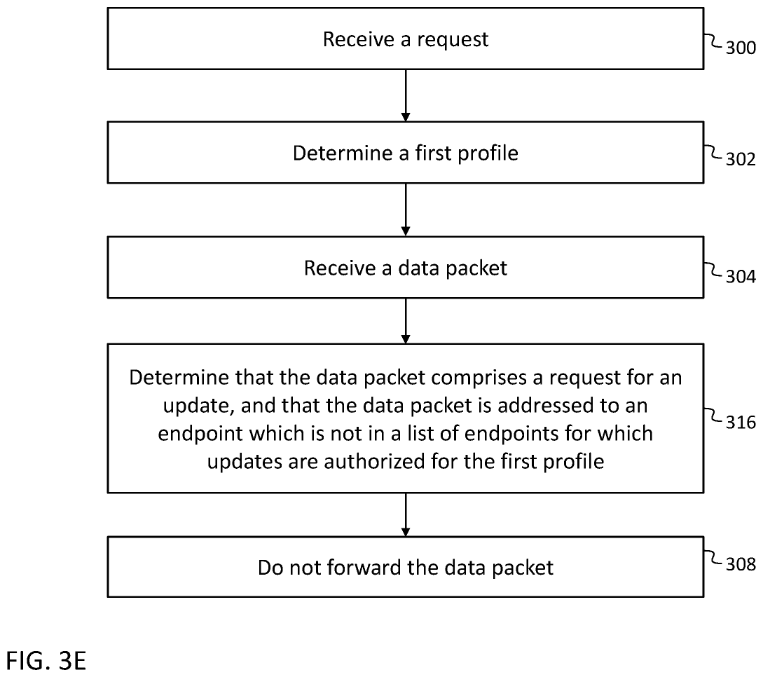

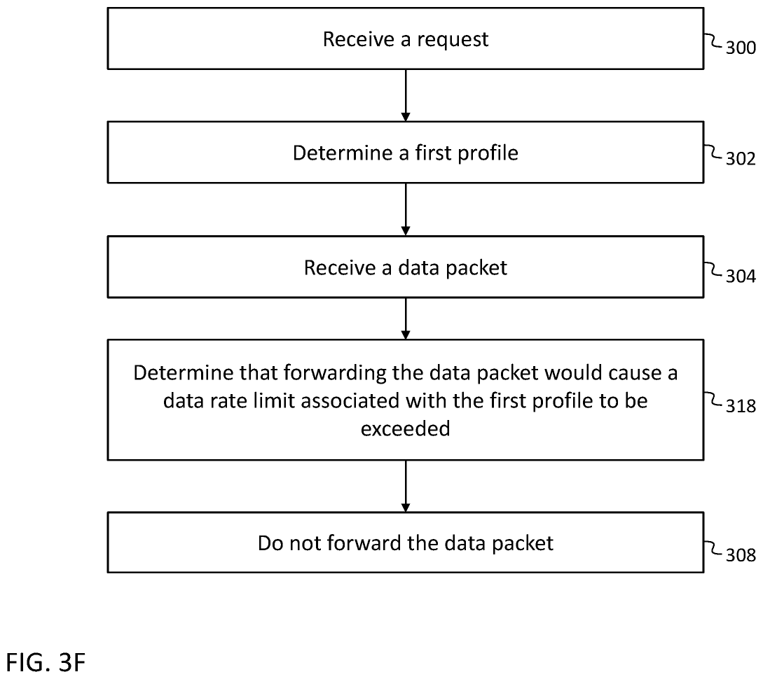

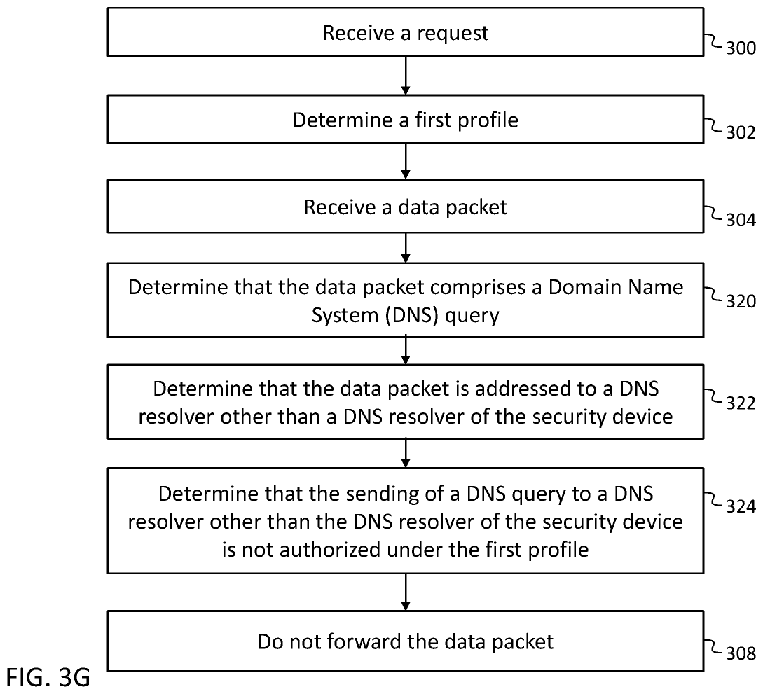

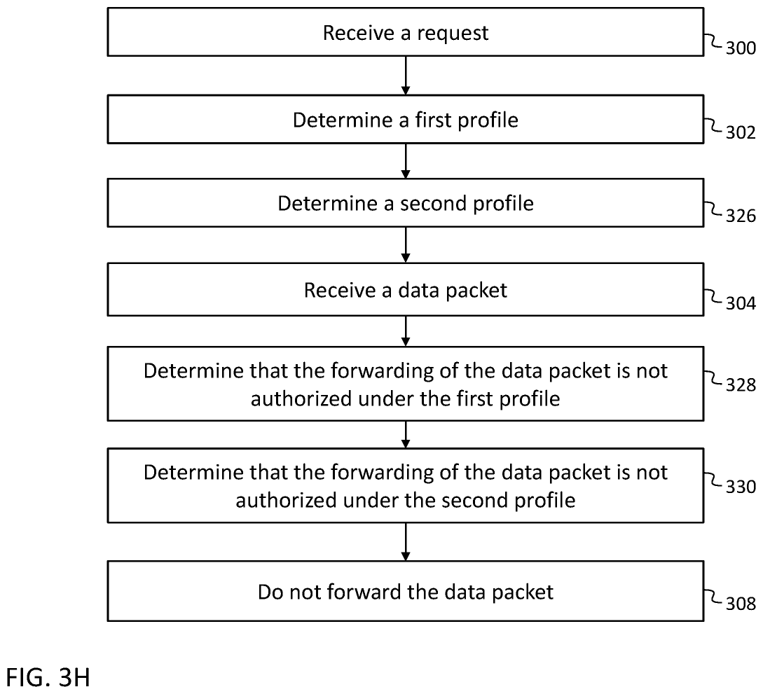

FIG. 3A is a flowchart of a method according to some embodiments described herein. A request is received, at 300, by a security device for a first network segment, from a device to be configured to receive or transmit data on the first network segment; a first profile for the device is determined, at 302, based on the request to be configured; a data packet is received, at 304, by the security device, the data packet being a data packet from the device, or a data packet addressed to the device; it is determined, at 306, by the security device, based on the first profile, that forwarding of the data packet is not authorized, and, at 308, the data packet is not forwarded by the security device. Referring to FIG. 3B, in some embodiments, the determining (at 306, in FIG. 3A) that the forwarding of the data packet is not authorized includes determining, at 310, that a port of the device to which the data packet is addressed is not associated with the first profile. Referring to FIG. 3C, in some embodiments, the determining (at 306, in FIG. 3A) that the forwarding of the data packet is not authorized includes determining, at 312, that an Internet Protocol (IP) address to which the data packet is addressed is the IP address of another device directly connected to the security device; and that the sending of data packets to another device directly connected to the security device is not authorized for the first profile. Referring to FIG. 3D, in some embodiments, the determining (at 306, in FIG. 3A) that the forwarding of the data packet is not authorized includes determining, at 314, that the data packet includes a request for an update and that the time of receipt of the data packet, by the security device, is not within a range of times for which updates are authorized for the first profile. Referring to FIG. 3E, in some embodiments, the determining (at 306, in FIG. 3A) that the forwarding of the data packet is not authorized includes determining, at 316, that: the data packet includes a request for an update; and the data packet is addressed to an endpoint which is not in a list of endpoints for which updates are authorized for the first profile. Referring to FIG. 3F, in some embodiments, the determining (at 306, in FIG. 3A) that the forwarding of the data packet is not authorized includes determining, at 318, that forwarding the data packet would cause a data rate limit associated with the first profile to be exceeded. Referring to FIG. 3G, in some embodiments, the determining (at 306, in FIG. 3A) that the forwarding of the data packet is not authorized includes: determining, at 320, that the data packet includes a Domain Name System (DNS) query; determining, at 322, that the data packet is addressed to a DNS resolver other than a DNS resolver of the security device; and determining, at 324, that the sending of a DNS query to a DNS resolver other than the DNS resolver of the security device is not authorized under the first profile. Referring to FIG. 3H, in some embodiments, the method further includes, determining, at 326, a second profile for the device, based on the request to be configured, and the determining (at 306, in FIG. 3A) that the forwarding of the data packet is not authorized includes determining, at 328, that the forwarding of the data packet is not authorized under the first profile; and determining, at 330, that the forwarding of the data packet is not authorized under the second profile.

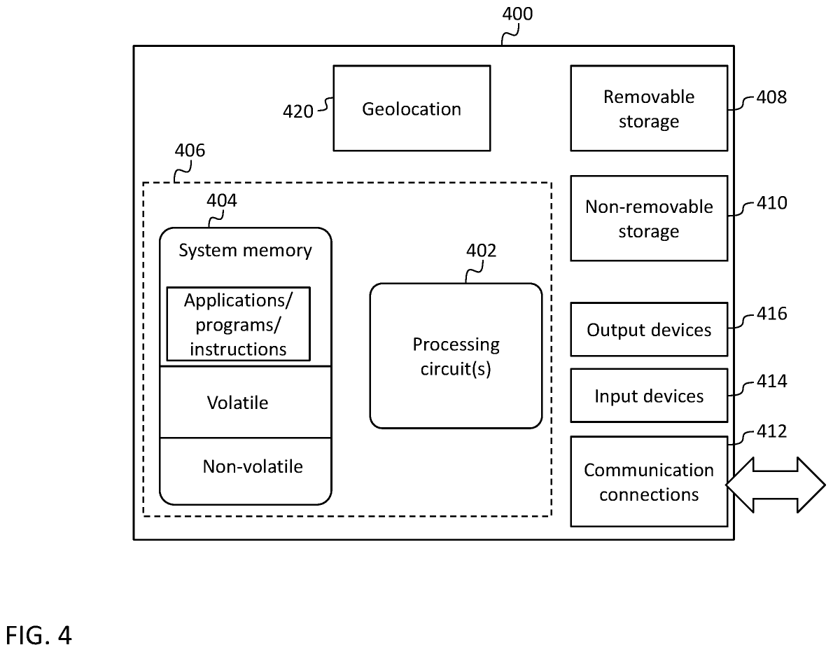

FIG. 4 depicts an example of a suitable operating environment 400 portions of which may be used to implement the security device 105 or a user computing device, or other computing devices within the systems discussed herein. In its most basic configuration, operating environment 400 typically includes at least one processing circuit 402 and memory 404. The processing circuit may be a processor, which is hardware. Depending on the exact configuration and type of computing device, memory 404 (storing instructions to perform the methods disclosed herein) may be volatile (such as RAM), nonvolatile (such as ROM, flash memory, etc.), or some combination of the two. This most basic configuration is illustrated in FIG. 4 by dashed line 406. The memory 404 stores instructions that, when executed by the processing circuit(s) 402, perform the processes and operations described herein. Further, environment 400 may also include storage (removable 408, or non-removable 410) including, but not limited to, solid-state, magnetic disks, optical disks, or tape. Similarly, environment 400 may also have input device(s) 414 such as keyboard, mouse, pen, voice input, etc., or output device(s) 416 such as a display, speakers, printer, etc. Additional communication connections 412 may also be included that allow for further communication with LAN, WAN, point-to-point, etc. Operating environment 400 may also include geolocation devices 420, such as a global positioning system (GPS) device.

Operating environment 400 typically includes at least some form of computer readable media. Computer readable media can be any available media that can be accessed by processing circuit 402 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is non-transitory and does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of any of the above should also be included within the scope of computer readable media.

As used herein, when a device is “directly connected” to a security device, it means that the device is connected to the security device without intervening switching or routing elements (e.g., hubs, switches, or other security devices) being present. As used herein, the word “or” is inclusive, so that, for example, “A or B” means any one of (i) A, (ii) B, and (iii) A and B. As used herein, when a method or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity. The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Although exemplary embodiments of a system and method for providing security to network-connected devices have been specifically described and illustrated herein, many modifications and variations will be apparent to those skilled in the art. Accordingly, it is to be understood that a system and method for providing security to network-connected devices constructed according to principles of this disclosure may be embodied other than as specifically described herein. The invention is also defined in the following claims, and equivalents thereof.

What is claimed is:

1. A method, comprising:
receiving, by a security device for a first network segment, a request from a connected device to be configured to receive or transmit data on the first network segment;
determining, based on the request to be configured, a first profile for the connected device;
receiving, by the security device, a data packet, the data packet being a data packet from the connected device, or a data packet addressed to the connected device;
determining, by the security device, based on the first profile, that forwarding of the data packet is not authorized; and
not forwarding, by the security device, the data packet.

2. The method of claim 1, wherein the request to be configured comprises a dynamic host configuration protocol (DHCP) message, and wherein the request to be configured comprises an indication of the first profile.

3. The method of claim 1, wherein the determining that the forwarding of the data packet is not authorized comprises determining that a port of the connected device to which the data packet is addressed is not associated with the first profile.

4. The method of claim 1, wherein the determining that the forwarding of the data packet is not authorized comprises determining that:
an Internet Protocol (IP) address to which the data packet is addressed is the IP address of another device directly connected to the security device; and
the sending of data packets to another device directly connected to the security device is not authorized for the first profile.

5. The method of claim 1, wherein the determining that the forwarding of the data packet is not authorized comprises determining that:
the data packet comprises a request for an update; and
the time of receipt of the data packet, by the security device, is not within a range of times for which updates are authorized for the first profile.

6. The method of claim 1, wherein the determining that the forwarding of the data packet is not authorized comprises determining that:
the data packet comprises a request for an update; and
the data packet is addressed to an endpoint which is not in a list of endpoints for which updates are authorized for the first profile.

7. The method of claim 1, wherein the determining that the forwarding of the data packet is not authorized comprises determining that forwarding the data packet would cause a data rate limit associated with the first profile to be exceeded.

8. The method of claim 1, wherein the determining that the forwarding of the data packet is not authorized comprises:
determining that the data packet comprises a Domain Name System (DNS) query;
determining that the data packet is addressed to a DNS resolver other than a DNS resolver of the security device; and
determining that the sending of a DNS query to a DNS resolver other than the DNS resolver of the security device is not authorized under the first profile.

9. The method of claim 1, further comprising determining, based on the request to be configured, a second profile for the connected device,
wherein the determining that the forwarding of the data packet is not authorized comprises:
determining that the forwarding of the data packet is not authorized under the first profile; and
determining that the forwarding of the data packet is not authorized under the second profile.

10. A security device for a first network segment, comprising:
a processing circuit configured to:
receive a request from a connected device to be configured to receive or transmit data on the first network segment;
determine, based on the request to be configured, a first profile for the connected device;
receive a data packet, the data packet being a data packet from the connected device, or a data packet addressed to the connected device;
determine, based on the first profile, that forwarding of the data packet is not authorized; and
not forward the data packet.

11. The security device of claim 10, wherein the request to be configured comprises a dynamic host configuration protocol (DHCP) message, and wherein the request to be configured comprises an indication of the first profile.

12. The security device of claim 10, wherein the determining that the forwarding of the data packet is not authorized comprises determining that a port of the connected device to which the data packet is addressed is not associated with the first profile.

13. The security device of claim 10, wherein the determining that the forwarding of the data packet is not authorized comprises determining that:
an Internet Protocol (IP) address to which the data packet is addressed is the IP address of another device directly connected to the security device; and
the sending of data packets to another device directly connected to the security device is not authorized for the first profile.

14. The security device of claim 10, wherein the determining that the forwarding of the data packet is not authorized comprises determining that:
the data packet comprises a request for an update; and
the time of receipt of the data packet, by the security device, is not within a range of times for which updates are authorized for the first profile.

15. The security device of claim 10, wherein the determining that the forwarding of the data packet is not authorized comprises determining that:
the data packet comprises a request for an update; and
the data packet is addressed to an endpoint which is not in a list of endpoints for which updates are authorized for the first profile.

16. The security device of claim 10, wherein the determining that the forwarding of the data packet is not authorized comprises determining that forwarding the data packet would cause a data rate limit associated with the first profile to be exceeded.

17. The security device of claim 10, wherein the determining that the forwarding of the data packet is not authorized comprises:
determining that the data packet comprises a Domain Name System (DNS) query;
determining that the data packet is addressed to a DNS resolver other than a DNS resolver of the security device; and
determining that the sending of a DNS query to a DNS resolver other than the DNS resolver of the security device is not authorized under the first profile.

18. The security device of claim 10, wherein:
the processing circuit is further configured to determine, based on the request to be configured, a second profile for the connected device; and
the determining that the forwarding of the data packet is not authorized comprises:
determining that the forwarding of the data packet is not authorized under the first profile, and
determining that the forwarding of the data packet is not authorized under the second profile.

19. A security device for a first network segment, comprising:
a processing circuit configured to:
receive a request from a connected device to be configured to receive or transmit data on the first network segment;
determine, based on the request to be configured, a first profile for the device;
receive a data packet, the data packet being a data packet from the connected device, or a data packet addressed to the connected device;
determine, based on the first profile, that forwarding of the data packet is not authorized by determining that (a) an Internet Protocol (IP) address to which the data packet is addressed is the IP address of another device directly connected to the security device; and (b) the sending of data packets to another device directly connected to the security device is not authorized for the first profile; and
dropping the data packet.

20. The security device of claim 19, wherein determining the first profile comprises receiving an indication of the first profile from the connected device, receiving confirmation of the first profile through a user interface, and storing an association between the first profile and the connected device.
